(19) United States
(12) Patent Application Publication
(10) Pub. No.: US 2026/0336632 A1
(43) Pub. Date: Oct. 29, 2026

(54) MICROWEATHER CLASSIFICATION

(71) Applicant: NETRADYNE, INC., San Diego, CA (US)

(72) Inventors: Amir PERSEKIAN, San Diego, CA (US); Arvind YEDLA, La Jolla, CA (US); Tarek NASSAR, San Diego, CA (US); Sachin Deepak LOMTE, Bengaluru (IN); Suresh Kumar YERAKARAJU, Bengaluru (IN)

(73) Assignee: NETRADYNE, INC., San Diego, CA (US)

(21) Appl. No.: 19/114,438

(22) PCT Filed: Sep. 21, 2023
(86) PCT No.: PCT/US23/33385

§ 371 Date: Mar. 22, 2025

Related U.S. Application Data
(60) Provisional application No. 63/409,513, filed on Sep. 23, 2022.

(51) Int. Cl. B60W 50/00; B60W 30/16; G05B 13/02; G06V 10/764; G06V 10/774; G06V 20/56

(52) U.S. Cl. CPC B60W 50/0097; B60W 30/16; B60W 50/0098; G05B 13/0265; G06V 10/764; G06V 10/7747; G06V 20/56; B60W 2050/0028; B60W 2420/403; B60W 2555/20; B60W 2754/30

(57) ABSTRACT

Systems and methods are provided for classification of weather from one or more images captured by a camera in a vehicle. The classification involves execution of a machine learning model to generate a plurality of environmental indicators based on the one or more images. The plurality of environmental indicators indicates the weather condition around the vehicle. In some embodiments, the plurality of environmental indicators is utilized to generate a weather map, which may include separate road condition and visibility condition indicators. The weather classification, alone or in combination with the weather map, may be used to modify the operation of a vehicle safety device or system.

### CROSS REFERENCE

This present application claims the benefit of and priority to U.S. Provisional Patent Application No. 63/409,513, filed on Sep. 23, 2022, and entitled MICROWEATHER CLASSIFICATION, the contents of which are incorporated herein by reference in its entirety.

### TECHNICAL FIELD

The present disclosure is related to machine learning models, particularly, to methods and systems to train and utilize machine learning models for weather classification.

### BACKGROUND

For driver monitoring and safety systems, characterizing the environment surrounding the driver can provide useful context. Characterizing the visibility of the driver is important as poor visibility may hinder the driver's ability to identify hazards or react to them. These hazards are elevated when a person is distracted or driving recklessly in poor visibility conditions associated with adverse weather. For driver monitoring and safety systems to be accurate and relevant, it may be helpful to analyze driver behavior differently in these environments.

Driver monitoring and safety systems, including self-driving control or assist modules, that are installed in vehicles may not be aware of the weather conditions occurring in the environment of the vehicle, including the vehicle's expected path of the travel. The driver monitoring systems may, in some scenarios, acquire weather data of a location from a public database that stores real-time and historical weather data, such as may be based on radar weather signals. The weather conditions reported by these databases, however, may not be accurate and may not match the real-time weather conditions in the immediate vicinity of the driver. Further, the weather report from these databases may not have adequate information pertaining to road conditions, such as whether a snowy road has been recently plowed. Therefore, for improved accuracy and relevancy of driver monitoring and safety systems, there is a need to accurately determine weather conditions in the vicinity of the vehicle based on sensor processing at edge devices installed in vehicles. Accordingly, certain aspects of the present disclosure are directed to classifying microweather in the vicinity of a vehicle, based at least in part on processing of visual data by an edge device that is coupled to one or more cameras on or in the vehicle.

### SUMMARY

Certain aspects of the present disclosure provide a method for weather classification. The method includes receiving an image captured by the camera mounted on or in a vehicle; and executing, by the at least one processor, a machine learning model using the image as input to generate a plurality of environmental indicators for an environment of the vehicle by: inserting, by the at least one processor, the image into a first set of layers of the machine learning model to generate an image embedding of the image; inserting, by the at least one processor, the image embedding into a second set of layers of the machine learning model to generate a weather prediction embedding; inserting, by the at least one processor, the weather prediction embedding into a plurality of sets of environment prediction layers; and generating, by the at least one processor, the plurality of environmental indicators for the environment of the vehicle.

Certain aspects of the present disclosure provide a system for weather classification. The system includes a processor and a memory coupled to the processor. The processor is configured to receive an image captured by the camera mounted on or in a vehicle. Further, the processor is configured to execute a machine learning model using the image as input to generate a plurality of environmental indicators for an environment of the vehicle by: inserting the image into a first set of layers of the machine learning model to generate an image embedding of the image; inserting the image embedding into a second set of layers of the machine learning model to generate a weather prediction embedding; inserting the weather prediction embedding into a plurality of sets of environment prediction layers; and generating the plurality of environmental indicators for the environment of the vehicle.

Certain aspects of the present disclosure provide a computer program product. The computer program product includes a non-transitory computer-readable medium that stores instructions. Upon execution, the instructions cause a computing device to perform one or more operations including receiving an image captured by the camera mounted on or in a vehicle; and executing a machine learning model using the image as input to generate a plurality of environmental indicators for an environment of the vehicle by: inserting the image into a first set of layers of the machine learning model to generate an image embedding of the image; inserting the image embedding into a second set of layers of the machine learning model to generate a weather prediction embedding; inserting the weather prediction embedding into a plurality of sets of environment prediction layers; and generating the plurality of environmental indicators for the environment of the vehicle.

### BRIEF DESCRIPTION OF THE DRAWINGS

Non-limiting embodiments of the present disclosure are described by way of example with reference to the accompanying figures, which are schematic and are not intended to be drawn to scale. Unless indicated as representing the background art, the figures represent aspects of the disclosure. For purposes of clarity, not every component may be labeled in every drawing.

FIG. 1 illustrates an example environment showing a computing system for training and using a machine learning model for object detection, according to an embodiment.

FIG. 2 illustrates a block diagram of an edge device, according to an embodiment.

FIG. 3 illustrates a block diagram of cloud computing device, according to an embodiment.

FIG. 4 illustrates neural network architecture of weather machine learning (ML) model, according to an embodiment.

FIG. 5 illustrates a representation of latent space, according to an embodiment.

FIG. 6A depicts a first example of training data, according to an embodiment.

FIG. 6B depicts a second example of training data, according to an embodiment.

FIG. 6C depicts a third example of training data, according to an embodiment.

FIG. 6D depicts a fourth example of training data, according to an embodiment.

FIG. 7 illustrates a flow of method for weather classification using a machine learning model, according to an embodiment.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented, or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Driver behavior monitoring involves characterizing driver behavior based on driving data. The driving data may include positional data, outward and in-cab facing visual data, and inertial sensor data.

A driver's behavior is affected by the visibility and weather conditions (such as rain, snow, fog, etc.) that occur in the environment. Safe driving behaviors tend to change, and a vehicle's motion signature tends to change as well, in response to changing road conditions. For example, it is more difficult for a vehicle to stop suddenly on an icy road, a driver may apply less braking power over a longer distance to come to a complete stop. For driver monitoring and safety systems, characterizing the environment surrounding the driver is helpful for accurately characterizing driver behavior in proper context. Characterizing the visibility of the driver is important as poor visibility may hinder the driver's ability to identify hazards or react to them.

The driver monitoring systems installed in vehicles may not be aware of the weather conditions occurring in the path of the travel. While some driver monitoring systems can acquire the weather data of a location from a public database that stores real-time and historical weather data, the weather conditions reported by these databases may not be accurate and may not match the real-time weather conditions around the vehicle. Further, the weather report from these databases may not have adequate information pertaining to road conditions. Therefore, for improved accuracy and relevancy of driver monitoring and safety systems, there is a need to accurately determine weather conditions in the vicinity of the vehicle.

To classify the weather conditions accurately, an edge device (i.e., driver monitoring system) installed on a vehicle may be enabled with certain aspects of the present disclosure so that it determines environmental indicators (e.g., weather identification parameters) based on the real-time visual data. The environmental indicators define various weather-related conditions that affect driving behavior. The environmental indicators can include one or more of visibility condition, road condition, windshield condition, or side-of-road condition, as explained below. The visual data is captured by the cameras included in the edge device or cameras external to the edge device but attached to the vehicle. The edge device includes machine learning models that output environmental indicators based on images captured by the cameras. Each environmental indicator may include a plurality of classes. The ML model can output a class for each environmental indicator based on the input image. Further, the ML model can aggregate the predicted environmental indicators of each image for a set of images and determine a class of each environmental indicator for a video including the set of images. The determined class of an environmental indicator for a video is the class that was predicted with a consistency greater than a consistency threshold over all the images in the video.

Upon determining the environmental indicators, the edge device can modify the driver behavior monitoring parameters and configuration settings for various alerts. For example, if visibility condition is fog, then an alert can be raised to turn on the fog lamps and headlights. In addition, or alternatively, the parameter that indicates distance to be maintained with vehicles ahead can be increased. Further, the edge device can communicate with a driver assistance system installed in the vehicle to modify vehicle control parameters based on the environmental indicators. To that effect, the edge device can indicate the control parameters of the driver assistance system that have to be updated based on the environmental indicators. For example, a driver assistance system control parameter may be a target braking distance for a smooth stop. In addition, the edge device can communicate the predicted environmental indicators (i.e., weather data, which may comprise visibility and/or road condition classification data) to a remote computing device (e.g., cloud computing system). The remote computing device can aggregate the weather data received from a plurality of edge device to generate a weather map based on the aggregated weather data.

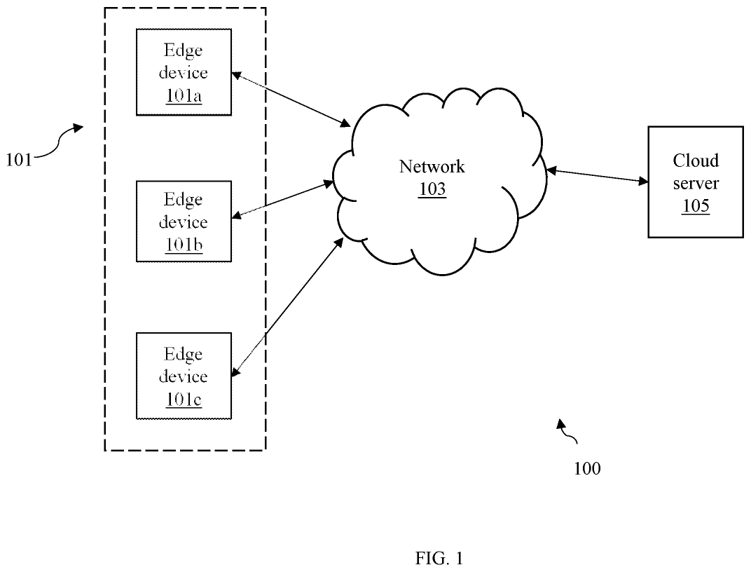

FIG. 1 illustrates an environment 100 that includes multiple components for weather classification and weather map generation. The environment 100 includes edge devices 101a, 101b, and 101c, that communicate with a cloud server 105 through a network 103. The edge devices 101a-101c are computing devices that may be installed in vehicles to monitor driver behavior.

The edge devices 101a-c and the cloud server 105 may connect to the network 103 using a wired network, a wireless network, or a combination of wired and wireless networks. Some non-limiting examples of wired networks may include the Ethernet, the Local Area Network (LAN), a fiber-optic network, and the like. Some non-limiting examples of wireless networks may include the Wireless LAN (WLAN), cellular networks, Bluetooth or ZigBee networks, and the like.

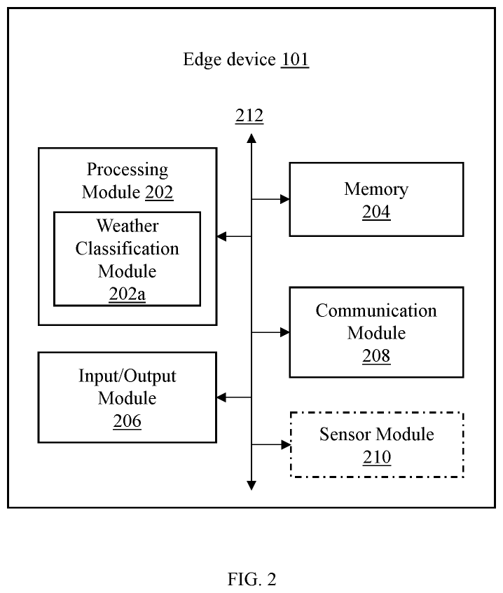

The edge device 101a is a computing device installed in the cabin of a vehicle to monitor driver behavior. The edge device 101a is configured to capture visual content that is processed by a machine learning model for weather classification. The edge device 101a may include one or more machine learning models configured to make inferences based on the visual content. The machine learning models may be deployed to the edge device 101a by the cloud server 105. Various components included in the edge device 101 are illustrated in FIG. 2.

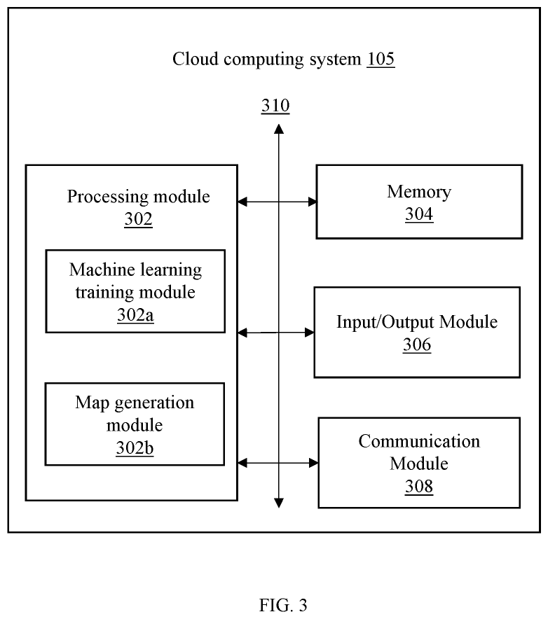

The cloud computing system 105 can be or include one or more computing devices that are configured to train and distribute machine learning models for weather classification from images and/or similar tasks relating to real-time operation of a vehicle. The cloud computing system 105 may transmit the machine learning models (e.g., copies of the machine learning model) to computing devices of vehicles (e.g., the edge device 101a) once the machine learning model or models are sufficiently trained. After transmitting the machine learning models to the edge devices 101a-c, the cloud computing system 105 can continue to train a local (local to the cloud) version of the machine learning models with training images to improve the machine learning models. In addition, the cloud computing device 105 can generate a weather map based on the weather data received from one or more edge devices 101. Various components included in the cloud computing system 105 are illustrated in FIG. 3. The cloud computing system includes a processing module 302, memory 304, an input/output module 306, a communication module 308, and a bus 310. The one or more components of the cloud computing system 105 communicate with each other via the bus 310.

To accurately train a machine learning model, it may be advantageous to identify the parameters that define weather classification in a way that can account for how various weather conditions appear in visual data that is captured from a camera mounted to a vehicle. In the present disclosure, weather classification involves characterizing the environment surrounding a driver of a vehicle by separately predicting visibility and road conditions using images as input. The visibility condition and the road condition are two environmental indicators that include various classes to indicate various weather conditions. The classes included in the visibility condition comprise clear, fog, rain, snow, and obstructed camera. The classes included in the road conditions comprise dry, wet, icy, and obstructed camera. In each of the visibility and road condition classes, the “obstructed camera” class may be used to indicate that the visual data is obstructed by something to such a degree that it is not possible or feasible to accurately characterize the visibility or road condition in the environment surrounding the vehicle on the basis of the visual data. In one embodiment, there can be more than two environmental indicators that help in characterizing the environment around the driver.

The machine learning model is trained to output a class for each indicator based on the input image. In one embodiment, the ML model can be a multi-headed model. Upon completion of training, the ML model is sent to edge devices 101a-c for deployment of the ML model, so that the models may process visual sensor data that are captured by a camera sensor proximate to each edge device.

### Training of the Machine Learning (ml) Model

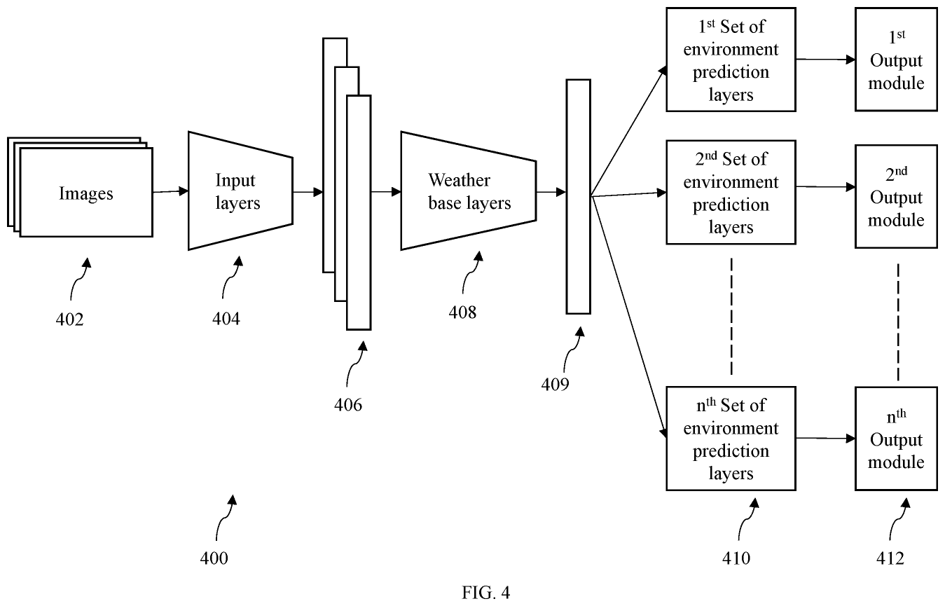

In one embodiment, the cloud computing system 105 is configured to train the machine learning (ML) model for weather classification. To that effect, the cloud computing system 105 includes a ML training module 302a to generate and train one or more ML models. The ML model for weather classification can be a neural network or a combination of one or more neural networks (shown in FIG. 4). The ML model 400 can include a plurality of neural network layers that process one or more input images 402. The plurality of neural network layers includes input layers 404, weather base layers 408, one or more sets of environment prediction layers 410. Each set of the one or more sets of environmental prediction layers 410 is associated with an environmental indicator. The ML model 400 is trained based on labelled input data 402 that includes images depicting diverse weather conditions.

In one embodiment, the input layers 404 can be a part of (and shared with) another ML model (not shown in FIG. 4) that is different from the weather ML model 400. The input layers 406 output a set of feature vectors 406 based on processing of an input image with the input layers 404. The set of feature vectors 406 represents features extracted from the input images in the form of vectors. The set of feature vectors 406 are provided to the weather base layers 408 that output another set of feature vectors, which may also be referred to as a weather prediction embedding vector 409. The another set of feature vectors (weather prediction embedding vector 409) are provided as an input to each set of the one or more sets of environment predictor layers 410, and each set of the one or more sets of environment prediction layers 410 output a probability distribution for an environmental indicator based on the weather prediction embedding vector 409 as processed by the set of environment prediction layers 410. The probability distribution includes a probability value associated with each class for all the classes of the environmental indicator, where the probability value for a class indicates the prediction of input image belonging to the class by the ML model 400. The summation of the values of the classes of the environmental indicator is equal to 1. For example, the probability distribution for a visibility condition from its set of environmental prediction layers can be ‘clear—0.1’, ‘fog—0.2’, ‘rain—0.5’, ‘snow—0.2’, and ‘obstructed camera—0’. In one embodiment, the class with the highest probability value is the predicted class for the environmental indicator. In another embodiment, the predicted class is the class with highest probability value satisfying a confidence threshold; the prediction of any of the output modules 412 of the weather ML model 400 is considered inaccurate if the highest probability value in that module 412 is not greater than the confidence threshold. After training, the confidence threshold may be tuned to select an appropriate trade-off between precision and recall of the ML model 400.

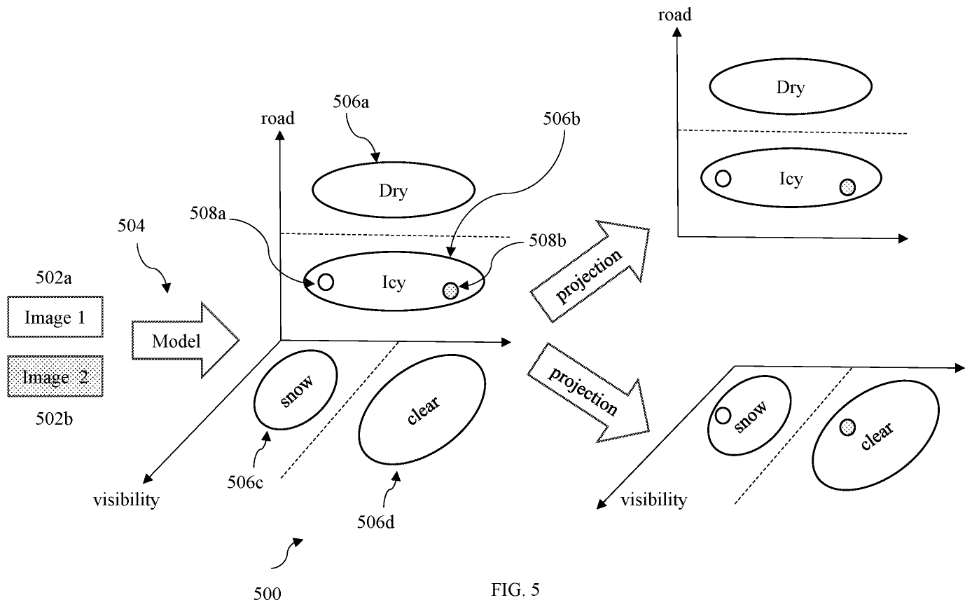

Further, the ML training module 302a compares predicted class of the environmental indicator with the label of the environmental indicator associated with the input image. The ML training module 302a determines a loss associated with each environmental indicator. Since the ML model 400 is a multi-headed model, the weather ML model is configured to predict a class for a plurality of environmental indicators. For example, the ML model 400 is configured to predict a class for visibility condition and road condition, which is further discussed with respect to FIG. 5. The ML training module 302a aggregates losses associated with each environmental indicator of the plurality of environmental indicators for an input image. The weather base layers, and environment prediction layers are updated to reduce the aggregated loss. To that effect, the ML training module 302a modifies weights associated with nodes in weather base layers 408 and environment predictor layers 410 using back propagation techniques to reduce the aggregated loss.

In one embodiment, the input layers 404 are frozen (i.e., excluded) during the training of the weather base layers 408 and the environment prediction layers 410 because the input layers can be part of another ML model that is trained to perform feature extraction, where the extracted feature vectors from the input layers 404 are provided as input to a plurality of ML models different from ML model 400.

The input data is provided with a label for at least one environmental indicator. The environmental indicator may include visibility condition, road condition, windshield condition, side-of-road condition, and the like. Each environmental indicator may include various classes. The ML model 400 is trained to output a class (or probabilities for each class) for each environmental indicator. In one embodiment, the cloud computing system 105 can access a database to retrieve stored training data.

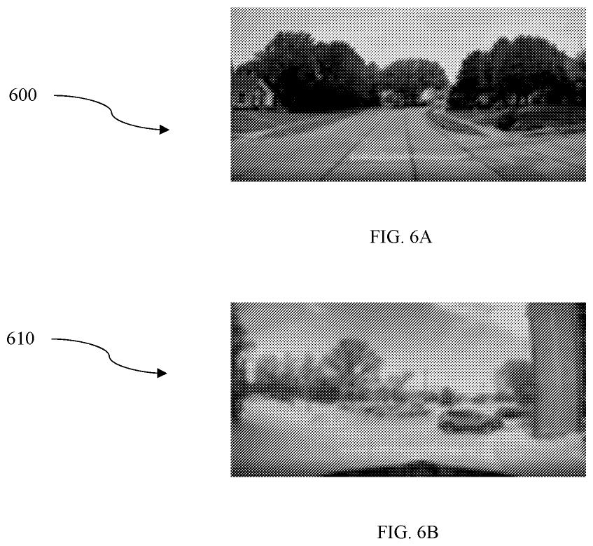

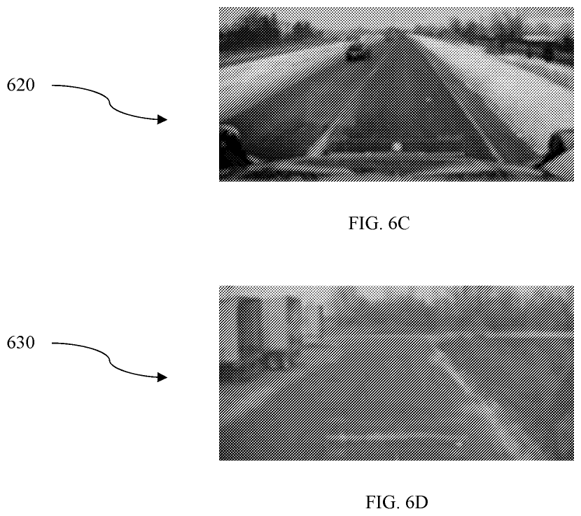

In another embodiment, the cloud computing system 105 can receive images captured by a computing device (such as the edge device 101a) and the images are labelled manually. To accurately train the ML model, all the environmental indicators are labelled for each training image, and training images are selected to collectively represent diverse situations and independent factors that occur in real-world situations. The windshield and side-of-road conditions may not affect the driver's behavior, but they are labelled for the input images to provide diverse combinations that occur with each environmental indicator. For example, clear road condition in an image may have snow side of road condition, another image may have clear road condition with clear side-of-road condition, and these training images may help the model to accurately derive the features that characterize the road condition, since these features may be only weakly affected by the visual appearance of the side of the road. Examples of training images can be seen in FIGS. 6A-6D. FIG. 6A depicts a training image 600 with labels for each environmental indicator. In the training image 600, the visibility condition is labeled as ‘clear’, road condition is ‘dry’, windshield condition is ‘clean’, and side-of-road condition is ‘nothing.’ FIG. 6B depicts a training image 610 with labels for each environmental indicator. In the training image 610, the visibility condition is labeled as ‘clear’, road condition is ‘snowy’, windshield condition is ‘clean’, and side-of-road condition is ‘snow.’ FIG. 6C depicts a training image 620 with labels for each environmental indicator. In the training image 620, the visibility condition is labeled as ‘clear’, road condition is ‘wet’, windshield condition is ‘clean’, and side-of-road condition is ‘snow.’ FIG. 6D depicts a training image 630 with labels for each environmental indicator. In the training image 630, the visibility condition is labeled as ‘snow’, road condition is ‘dry’, windshield condition is ‘clean’, and side-of-road condition is ‘nothing.’Video based weather classification In one embodiment, the weather ML model (e.g., ML model 400) is trained to process an input image to predict a class for environmental indicator. Upon completion of training of the weather ML model, the cloud computing system 105 transmits the weather ML model to edge devices 101a-c for deployment of weather ML model on the edge devices 101a-c.

The edge device 101a is configured to capture visual data (i.e., images and videos) corresponding to the path being travelled by a vehicle. The visual data is processed by one or more ML models deployed on the edge device 101a. Upon deployment of the weather ML model on the edge device 101a, the edge device 101a processes the visual data using the weather ML model. At the edge device 101a, the weather ML model outputs a class (or probability of each class) associated with each of one or more environmental indicators for the captured image. The captured image can be part of a video of length L seconds. The weather conditions that occur during the drive session of the vehicle persist for more than one frame/image. In order to increase confidence in a prediction of an occurrence of a weather condition, the predictions for individual image are aggregated for a video of length L. However, the predictions of environmental indicators for consecutive frames/images may tend to vary from each other. For example, the predictions for a first image in the video can be visibility—‘clear’ and road condition—‘dry’ and the predictions for a forth image in the video can be visibility—‘clear’ and road condition—‘wet’. In such cases, the edge device 101a is configured to measure the consistency of predicted environmental indicators for the video and generate a record including the predicted weather conditions if the consistency is greater than a consistency threshold.

For example, the video can be of length 2 sec with processing of outward camera frames at 5 fps, and the weather ML model is trained to process the 10 frames of the video. The weather ML model is configured to output a plurality of environmental indicators for each frame in the video. The environmental indicators of all the frames in the video are compared among each other. For each environmental indicator, the cloud computing system 105 is configured to compare the highest number of times a class is predicted for all the frames in the video with a consistency threshold. If the highest number of times a class is predicted for the video is greater than the consistency threshold, the class with highest number of predictions is the predicted class for the video of that environmental indicator. For example, if the video has 10 frames and the visibility condition for 10 frames is predicted to be ‘clear’ for 8 frames and ‘fog’ for 2 frames, then the visibility condition for the video is determined as ‘clear’ if the consistency threshold is ‘7’. If the highest number of times a class is predicted for the video is lower than the consistency threshold, then the video-based weather prediction is considered indecisive. The consistency threshold can be changed to trade-off precision or recall. In some embodiments, the consistency threshold may be changed dynamically during operation depending on recent weather data collected and aggregated in the cloud computing system 105 and communicated to the edge device.

In one embodiment, an edge device 101a may be configured to generate a record of weather data that preferentially highlights changes to the observed road condition and/or visibility condition in the vicinity of the vehicle. For example, after driving on a dry road with clear visibility for some time, the vehicle may encounter a location with rain. As explained above, the edge device 101a may process a plurality of new images collected as the vehicle enters the portion of the road where it is raining. If the number of frames (e.g. 6) over a period of time (e.g. 2 seconds) that are detected as ‘rain’ by the visibility condition head exceeds a threshold (e.g. 5) then the edge device may create a record that rain has started. The edge device 101a may then communicate this inference together with location data and time data to a cloud computing system 105. This information may then be used by the cloud computing system 105 to update a map of microweather, such that rain is indicated at the communicated location but not at locations where the edge device had recently travelled.

Continuing with this example, the edge device 101a may continue to process additional frames. For a time, it may be expected that the edge device 101a will continue to detect that the visibility condition is ‘rain’ even though there may be individual frames for which the processing results in a different visibility condition inference. In some embodiments, the edge device 101a may communicate weather data less frequently or not at all as long as the weather inference remains the same. However, when the weather inference changes, such as when the vehicle has travelled beyond the area of rain, then then edge device 101a may once again preferentially make a record of the change to the visibility condition and communicate this information to the cloud computing system 105. The cloud computing system 105 may use the communicated data to update the map of microweather. The cloud computing system 105 may, for example, fill in the map of microweather so that rain is indicated at locations of the edge device 101 spanning from the first to the last detections of rain.

In some embodiments, the edge device 101a may make consistency threshold checks over equal-sized time periods, such as 2 seconds as in the above example, or over a longer interval, such as one minute. In such embodiments, a first consistency check is performed whenever the set of images that have been processed by the machine learning model (e.g., ML model 400) reaches a predetermined size (e.g. one minute of processed frames). Then, in response to the edge device processing a second set of images having a second size equal to the first size (corresponding to a second minute recorded at a later time), then the edge device 101a will determine if the plurality of environmental indicators satisfy a consistency threshold. If the new weather data inferences indicate a change between the environmental indicators, then the edge device 101a will generate a second record identifying the new environmental indicators. Alternatively, or in addition, the edge device 101 will generate a record identifying the detected change. As above, the new environmental indicators and/or the record of the detected change can be used by the cloud computing system 105 to efficiently update a map of microweather over a span of vehicle locations associated with the edge device 101.

Using equal-sized time periods may help the cloud computing system 105 maintain accurate weather map data over a diverse family of edge devices 101. Accordingly, the separate specification of road condition and road visibility, itself or together with a specification of a number of inferences over which a weather classification may be considered reliable, may comprise a microweather classification protocol that enables multiple edge devices to communicate and effectively share microweather inferences.

### Edge Device

FIG. 2 depicts a block diagram of an edge device 101 that is installed in a vehicle for monitoring driver behavior. The edge device 101 includes a processing module 202, memory 204, an input/output module 206, a communication module 208, a sensor module 210, and a bus 212. The one or more components of the edge device 101 communicate with each other via the bus 212.

In one embodiment, the processing module 202 may include a microprocessor, an application-specific integrated circuit (ASIC), a field-programmable gate array (FPGA), a graphics processing unit (GPU), etc. or combinations thereof. The processing module 202 executes stored processor-executable instructions to perform one or more of the operations described herein. The processing module 202 is depicted to include a weather classification module 202a.

The memory 204 may include, but is not limited to, electronic, optical, magnetic, or any other storage or transmission device capable of providing the processor with program instructions. The instructions may include code from any suitable computer programming language. The memory 204 stores processor-executable instructions and algorithms that are executed by the weather classification module 202a.

The input/output module 206 (hereinafter referred to as an ‘I/O module 206’) may include mechanisms configured to receive inputs from and provide outputs to the operator(s) of the edge device 101. To that effect, the I/O module 160 may include at least one input interface and/or at least one output interface. Examples of the input interface may include, but are not limited to, a keypad, a touch screen, soft keys, a microphone, and the like. Examples of the output interface may include, but are not limited to, a display, a speaker, a haptic feedback seat, haptic feedback steering wheel, and the like. In an example embodiment, the processing module 202 may include I/O circuitry configured to control at least some functions of one or more elements of the I/O module 206, such as, for example, a speaker, a microphone, a display, and/or the like. The processing module 202 and/or the I/O circuitry may be configured to control one or more functions of the one or more elements of the I/O module 206 through computer program instructions, for example, software and/or firmware, stored on a memory, for example, the memory 204, and/or the like, accessible to the processing module 202.

The communication module 208 may include communication circuitry such as for example, a transceiver circuitry including an antenna and other communication media interfaces to connect to a communication network, such as the network 103 shown in FIG. 1.

The sensor module 210 may include cameras and one or more inertial sensors. In one embodiment, the sensor module 210 can be external to the edge device 101 and connected to the edge device 101 through wired or wireless communication means. The sensor module 210 may include an inward facing camera and an outward facing camera. The one or more inertial sensors may include accelerometers and gyroscopes. The outward facing camera may capture visual information corresponding to the road in front of the vehicle (which may be the path to be travelled by the vehicle) whereas the inward facing camera may capture visual information corresponding to the driver and cabin of the vehicle.

In one embodiment, the sensor module 210 may capture images corresponding to the road ahead of the vehicle (which may be the path to be travelled by the vehicle) and send the images to the processing module 202. The images may correspond to a video. The images can be tagged with time stamps and GPS coordinates associated with time and place of capture of the image by the sensor module 210.

The processing module 202 receives the captured images and processes the captured images using the machine learning model (e.g., ML model 400). In one embodiment, the processing module 202 may include a preprocessing module (not shown in FIG. 2) to preprocess the image prior to feeding the image to the ML model 400. The preprocessing module may format the image to a predefined format acceptable by the ML model 400. In one example, the preprocessing module may downsize the resolution of the captured image if the ML model 400 is trained on images with lower resolution.

The communication module 208 receives the ML model 400 from the cloud computing system 105. The processing module 202 can further include a weather classification module 202a for vision-based classification of local weather conditions (microweather) in real-time or near real-time. The weather classification module can include one or more ML models that are trained to process images and output an inference based on the images. In one embodiment, at least one machine learning model included in the weather classification module 202a is a multi-headed neural network model. The one or more ML models may be received by the edge device 101 from the cloud computing system 105 upon completion of the training of the ML models, periodically, when entering a new territory, and the like.

In one embodiment, the images 502 captured by the cameras may be processed to extract a feature vector that is projected into a weather embedding space 500 (shown in FIG. 5). The feature vector can be generated from the image with the use of one or more neural network layers of the ML model 504 (i.e., weather ML model 400). An embedding space may be a multi-dimensional intermediate layer of a neural network, such as the weather prediction embedding space layer 409 of the ML model 400 that is trained to perform weather classification. The embedding space depicted in FIG. 5 includes two dimensions corresponding to road condition and visibility condition. The feature vectors are further projected onto road condition dimension and visibility condition dimension. Each plane includes one or more clusters 506a, 506b, 506c, and 506d, in which each cluster is related to a class of the environmental indicator. The cluster is determined after the completion of training of the ML model 400 and the cluster is represented by a feature vector. The size of the cluster can change upon training of the ML model 400 using diverse training data. The feature vectors of image 502a and image 502b are projected into ‘Icy’ class cluster 506b, at locations 508a and 508b, respectively, in the embedding space of the road condition parameter. Further, the feature vector of image 502a is projected into ‘Snow’ class cluster 506c of visibility parameter and image 502b is projected into ‘Clear’ class cluster 506d of the visibility parameter.

The road condition and visibility parameters are environmental indicators for the environment of the vehicle. The road condition and visibility parameters are predicted for each image of a video. A video prediction is determined by aggregating image level predictions of the image in the video. The parameters for each image are compared with the other images in the video. For example, the parameters of an image are compared with the parameters of the prior and post image of the current image to determine a consistency value of the parameters. If the consistency values of the parameters are less than a consistency threshold, then the predictions for the video are deemed to have low confidence.

### Vehicle Parameter Modification

In one embodiment, the edge device 101a is configured to communicate with another computing device installed in the vehicle. The other computing device can be part of the autonomous driver assistance system (ADAS) installed in the vehicle for autonomous driving or to assist driver in driving the vehicle. The ADAS system controls one or more vehicle parameters to facilitate safe driving of the vehicle. However, some of the ADAS systems may not be aware of the weather conditions that occur in the path travelled and these ADAS systems may not consider the weather conditions while controlling the vehicle. This type of control of the vehicle may not be safe considering the adverse effects the weather conditions have on the movement of the vehicle. For example, the vehicle may not come to a quick stop if the vehicle is travelling on a wet or snowy road compared to the dry road. To overcome these drawbacks, provision of weather conditions to the ADAS system is disclosed to enhance safety in controlling the vehicle.

In one embodiment, the edge device 101a communicates the predicted environmental indicators to the computing device (i.e., ADAS system) installed in the vehicle. For example, the edge device 101a can send the predicted classes for one or more environmental indicators such as visibility condition and road condition, etc. to the ADAS system. The ADAS system can modify the vehicle control parameters based on the environmental indicators. In one embodiment, the ADAS system can increase or decrease the vehicle braking distance based on at least one environmental indicator. For example, the ADAS system can decrease the vehicle braking distance if the road condition is predicted as dry and can increase the vehicle braking distance if the road condition is predicted as snowy or wet. Similarly, the ADAS system can increase the vehicle braking distance if the visibility condition is snow, rain, or fog. In one embodiment, the ADAS system can select an action that controls the vehicle based on the modified vehicle control parameter. In one embodiment, the actions include activation of a windshield wiper, application of brakes, activation of emergency lights, etc. For example, the ADAS system can change the time at which brakes are activated based on the modified vehicle braking distance (i.e., vehicle control parameter).

The vehicle braking distance is a numerical value that indicates the distance a vehicle will travel from the point when its brakes are fully applied to when the vehicle comes to a complete stop. The vehicle braking distance is a control parameter of the vehicle that is calculated by the ADAS system based on a real-time braking event. For example, the ADAS system can calculate the braking distance if the driver applies brakes to stop the vehicle on the road. Further, the ADAS system can iteratively calculate the braking distance for different velocities on the same road. Upon receiving the weather conditions from the edge device 101a, the ADAS system can update the vehicle braking distance based on the predicted weather condition.

In another embodiment, the edge device 101a can be part of the ADAS system and the edge device 101a can modify/adjust one or more vehicle control parameters according to the predicted environmental indicators. Further, the edge device can select an action from a set of actions to control the vehicle according to at least one adjusted vehicle control parameter. The actions include activation of a windshield wiper, application of brakes, activation of emergency lights, etc.

### Weather Map Generation

In one embodiment, the cloud computing system 105 includes a weather map generation module 302b. The weather map generation module 302b is configured to receive weather data from edge devices 101a-c installed in the respective vehicles. The weather data may include predicted classes for environmental indicators determined by the edge devices 101a-c using the ML models. For example, the weather data may include a predicted class for each environmental indicator from an edge device. The weather data can further include time stamps associated with images and/or weather inferences of the edge device.

Further, the weather map generation module 302b is configured to receive location data from edge devices 101a-c. In one embodiment, the location data can include GPS coordinates of the vehicle. In another embodiment, the location data can include time stamps associated with respective GPS coordinates. Further, the weather data can be tagged with respective location data by the edge device that detected the weather data, prior to sending the weather data to the cloud computing system 105.

Upon receiving weather data and location data from any of the edge devices 101, such as edge device 101a, the weather map generation module 302b is configured to process the data and associate the weather data with respective location data. For example, the weather map generation module 302b assigns the weather data to one or more GPS coordinates.

In one embodiment, the weather map generation module 302b is configured to retrieve map data from an external database that stores maps of different regions. The external database can be managed as a service provider and the external database can be accessed through an API interface by the weather map generation module 302b. In one example, the weather map generation module 302b can generate the map from the received map data and divide the map into grid cells of equal area (e.g., one square kilometer). Each grid cell can include a plurality of location datapoints that correspond to a location.

In one embodiment, the weather map generation module 302b can cluster the location tagged weather data into respective grid cells based on the location datapoints present in the grid cells. Further, the weather map generation module 302b is configured to determine the weather conditions for each grid cell based on the weather data of the location datapoints in the grid cell. The weather map generation module 302b assigns a visibility condition to the grid cell based on the most predicted visibility condition in the clustered weather data of the respective grid cell. Later, the weather map generation module 302b can generate a weather map including the grid cells and their associated weather conditions (i.e., environmental indicators), by grouping the grid cells. The weather map can include the time lapsed from the time at which the weather condition was assigned to that grid cell. Each grid cell can indicate the weather conditions and time lapsed describing the newness of the weather condition.

In another embodiment, the weather map generation module 302b can match the weather data onto the road segments based on the location datapoints associated with road segments. The information related to the location datapoints associated road segments is retrieved from the external database. The weather map generation module 302b can generate a weather map including the road segments and their associated weather data. The road segment can include the weather conditions and time lapsed describing the newness of the weather conditions. For example, a road segment can be indicated with a visibility condition as ‘rain’ and a road condition as ‘wet’ in the weather map. Further, the weather map generation module 302b can modify at least weather condition based on the time lapsed. For example, after a period of time has elapsed, the weather map generation module 302b can change the road condition to ‘wet’ if the visibility condition was identified as ‘rain’ and the road condition was identified as ‘dry’. Similarly, the map may contain an indicator that the location is likely to be wet, but unconfirmed, which could affect subsequent edge device processing by decreasing the confidence threshold required to classify the road as wet in that location.

In one embodiment, the generated weather map can be a heat map that includes a color scale according to the determined weather conditions (i.e., environmental indicators). To that effect, the grid cell or the road segment in the weather map can be assigned a color based on visibility condition determined for the grid cell or the road segment. For example, the grid cell in the weather map can be colored ‘blue’ if the visibility condition is determined as ‘rain’.

Further, the generated weather map is sent to the edge device such that the edge device can utilize the weather map to generate timely alerts for the driver. Prior to generating and raising the alerts, the edge device may verify the weather map with real-time weather condition predictions and raise alerts upon successful verification. Upon unsuccessful verification (i.e., weather map data not matching the with real-time predicted weather conditions), the edge device can update the weather map and send the updated weather map to the cloud computing system. In another embodiment, the edge device can send newly predicted weather conditions to the cloud computing system upon unsuccessful verification of the weather map.

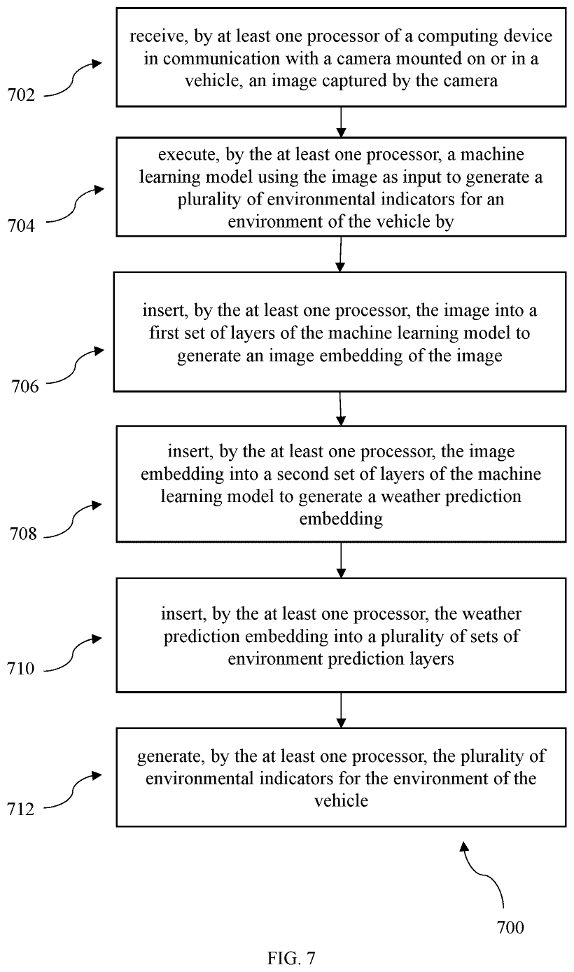

FIG. 7 illustrates a flow of a method 700 executed by a data processing system (e.g., the edge device 101, the cloud computing system 105, combinations thereof, etc.) for weather classification, according to an embodiment. The method 700 may include steps 702-712. However, other embodiments may include additional or alternative steps, or may omit one or more steps altogether.

In step 702, the data processing system may receive an image captured by a camera mounted on or in a vehicle. In step 704, the data processing system may execute a machine learning model using the image as input to generate a plurality of environmental indicators for an environment of the vehicle by performing steps 706-712. The cloud computing system may train a machine learning model to classify weather conditions based on the images. In step 706, the data processing system may insert the image into a first set of layers of the machine learning model to generate an image embedding of the image. In step 708, the data processing system may insert the image embedding into a second set of layers of the machine learning model to generate a weather prediction embedding. In step 710, the data processing system may insert the weather prediction embedding into a plurality of sets of environment prediction layers. In step 512, the data processing system may generate the plurality of environmental indicators for the environment of the vehicle.

The various illustrative logical blocks, modules, circuits, and algorithm steps described in connection with the embodiments disclosed herein may be implemented as electronic hardware, computer software, or combinations of both. To illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure or the claims.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The operations described in this specification can be implemented as operations performed by a data processing apparatus on data stored on one or more computer-readable storage devices or received from other sources.

The terms “data processing apparatus”, “data processing system”, “client device”, “computing platform”, “computing device”, “computing system”, “user device”, or “device” can encompass all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA or an ASIC. The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read-only memory or a random access memory or both. The elements of a computer include a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a GPS receiver, a digital camera device, a video camera device, or a portable storage device (e.g., a universal serial bus (USB) flash drive), for example. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), plasma, or LCD monitor, for displaying information to the user; a keyboard; and a pointing device, e.g., a mouse, a trackball, or a touchscreen, by which the user can provide input to the computer. Other kinds of devices can be used to provide for interaction with a user as well; for example, feedback provided to the user can include any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user.

In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. For example, the computing devices described herein can each be a single module, a logic device having one or more processing modules, one or more servers, or an embedded computing device.

Having now described some illustrative implementations and implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed only in connection with one implementation are not intended to be excluded from a similar role in other implementations or implementations.

The phraseology and terminology used herein is for the purpose of description and should not be regarded as limiting. The use of “including,” “comprising,” “having,” “containing,” “involving,” “characterized by,” “characterized in that,” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation, and references to “an implementation,” “some implementations,” “an alternate implementation,” “various implementation,” “one implementation,” or the like are not necessarily mutually exclusive and are intended to indicate that a particular feature, structure, or characteristic described in connection with the implementation may be included in at least one implementation. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms.

Where technical features in the drawings, detailed description or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The preceding description of the disclosed embodiments is provided to enable any person skilled in the art to make or use the embodiments described herein and variations thereof. Various modifications to these embodiments will be readily apparent to those skilled in the art, and the principles defined herein may be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

1. A method comprising:
receiving, by at least one processor of a computing device in communication with a camera mounted on or in a vehicle, an image captured by the camera; and
executing, by the at least one processor, a machine learning model using the image as input to generate a plurality of environmental indicators for an environment of the vehicle by:
inserting, by the at least one processor, the image into a first set of layers of the machine learning model to generate an image embedding of the image;
inserting, by the at least one processor, the image embedding into a second set of layers of the machine learning model to generate a weather prediction embedding;
inserting, by the at least one processor, the weather prediction embedding into each set of environment prediction layers in a plurality of sets of environment prediction layers, wherein each set of environment prediction layers outputs a probability distribution for a respective environmental indicator based on the weather prediction embedding; and
generating, by the at least one processor, the plurality of environmental indicators for the environment of the vehicle based on the probability distributions.

2. The method of claim 1, further comprising:
transmitting, by the at least one processor, the plurality of environmental indicators to a second processor controlling the vehicle, the second processor controlling the vehicle according to the plurality of environmental indicators.

3. The method of claim 2, wherein the second processor controls the vehicle according to the plurality of environmental indicators by:
adjusting one or more vehicle control parameters based on the plurality of environmental indicators; and
selecting an action to control the vehicle based on the adjusted one or more vehicle control parameters.

4. The method of claim 3, wherein an adjustment to the one or more vehicle control parameters comprises increasing a vehicle braking distance value.

5. The method of claim 1, wherein the plurality of sets of environment prediction layers comprises a first set of environment prediction layers predicting a visibility condition and a second set of environment prediction layers predicting a road condition.

6. The method of claim 5, wherein the plurality of sets of environment prediction layers further comprises a third set of environment prediction layers predicting a windshield condition and a fourth set of environment prediction layers predicting a side-of-road condition

7. The method of claim 1, comprising:
receiving, by the at least one processor, a first set of images from the camera;
executing, by the at least one processor, the machine learning model using each image of the set of images as input to generate a second plurality of environmental indicators for the environment of the vehicle for the image of the first set of images;
determining, by the at least one processors, that the second plurality of environmental indicators satisfy a consistency threshold based on a number of each of the second plurality of environmental indicators generated based on the first set of images; and
responsive to determining the second plurality of environmental indicators satisfy the consistency threshold, generating, by the at least one processor, a record identifying the second plurality of environmental indicators.

8. The method of claim 7, wherein the first set of images has a first size, and further comprising:
receiving, by the at least one processor subsequent to receiving the first set of images, a second set of images from the camera;
executing, by the at least one processor, the machine learning model using each image of the second set of images as input to generate a third plurality of environmental indicators for the environment of the vehicle for the image of the second set of images;
responsive to the second set of images having a second size equal to the first size, determining, by the at least one processor, the third plurality of environmental indicators satisfy the consistency threshold; and
responsive to detecting a change between the second plurality of environmental indicators and the third plurality of environmental indicators, generating, by the at least one processor, a second record identifying the third plurality of environmental indicators.

9. The method of claim 1, further comprising:
receiving by the at least one processor, a plurality of environmental labels for a training image, each label corresponding to a different set of the plurality of sets of environment prediction layers;
executing, by the at least one processor, the machine learning model using the training image as input to obtain an output environmental indicator distribution from each of the plurality of sets of environment prediction layers; and
training, by the at least one processor, each of the plurality of sets of environment prediction layers according to the label that corresponds to the set of environment prediction layers and the output environmental indicator distribution from the set of environment prediction layers.

10. The method of claim 9, further comprising:
training by the at least one processor, the second set of layers, by:
calculating, by the at least one processor, a difference for each of the plurality of sets of environment prediction layers based on the label that corresponds to the set of environment prediction layers and the output environmental indicator distribution from the set of environment prediction layers;
aggregating, by the at least one processor, the calculated differences for the plurality of sets of environment prediction layers according to a loss function to obtain an aggregated difference; and
using, by the at least one processor, a back-propagation technique with the aggregated difference on the second set of prediction layers.

11. The method of claim 10, wherein aggregating the calculated differences for the plurality of sets of environment prediction layers comprises aggregating, by the at least one processor, the calculated differences according to weights assigned to the plurality of sets of environment prediction layers.

12. The method of claim 1, further comprising:
generating, by the at least one processor, a record based on the plurality of environmental indicators; and
transmitting, by the at least one processor, the record to a remote computing device across a network.

13. The method of claim 1, wherein executing the machine learning model comprises:
selecting, by the at least one processor, an environmental indicator from the plurality of potential environmental indicators responsive to the environmental indicator having a probability distribution that satisfies a condition.

14. A system comprising:
a processor of a computing device in communication with a non-transitory memory of the computing device and a camera mounted on or in a vehicle, wherein the processor is configured to:
receive an image captured by the camera; and
execute a machine learning model using the image as input to generate a plurality of environmental indicators for an environment of the vehicle by:
inserting the image into a first set of layers of the machine learning model to generate an image embedding of the image;
inserting the image embedding into a second set of layers of the machine learning model to generate a weather prediction embedding;
inserting the weather prediction embedding into each set of environmental prediction layers in a plurality of sets of environment prediction layers, wherein each set of environment prediction layers outputs a probability distribution for a respective environmental indicator based on the weather prediction embedding; and
generating the plurality of environmental indicators for the environment of the vehicle based on the probability distributions.

15. The system of claim 14, wherein the processor is further configured to:
transmit the plurality of environmental indicators to a second processor controlling the vehicle, the second processor controlling the vehicle according to the plurality of environmental indicators.

16. The system of claim 15, wherein the second processor controls the vehicle according to the plurality of environmental indicators by:
adjusting one or more vehicle control parameters based on the plurality of environmental indicators; and
selecting an action to control the vehicle based on the adjusted one or more vehicle control parameters.

17. The system of claim 16, wherein an adjustment to the one or more vehicle control parameters comprises increasing a vehicle braking distance.

18. A method comprising:
receiving, by at least one processor of a computing device in communication with a camera mounted on or in a vehicle, a set of images captured by the camera;
executing, by the at least one processor, a machine learning model having a plurality of sets of environment prediction layers for each image of the set of images as input to generate a plurality of environmental indicators for an environment of the vehicle for each image of the set of images; and
selecting, by the at least one processor, an environmental indicator for at least one of the plurality of sets of environment prediction layers responsive to the environmental indicator exceeding a consistency threshold.

19. The method of claim 18, further comprising:
transmitting, by the at least one processor, the selected environmental indicators to a second processor controlling the vehicle, the second processor controlling the vehicle according to the selected environmental indicators by:
adjusting one or more vehicle control parameters based on the selected environmental indicators; and
selecting an action to control the vehicle based on the adjusted one or more vehicle control parameters.

20. The method of claim 18, wherein the set of images is a first set of images having a first size and the selected environmental indicator for each of plurality of sets of environmental indicators is a selected first environmental indicator, and further comprising:
receiving, by the at least one processor subsequent to receiving the first set of images, a second set of images from the camera;
executing, by the at least one processor, the machine learning model using each image of the second set of images as input to generate a second plurality of environmental indicators for the environment of the vehicle for the image of the second set of images;
responsive to the second set of images having a second size equal to the first size, selecting, by the at least one processor, a second environmental indicator for each of the plurality of sets of environment prediction layers responsive to the second environmental indicator being included in a number of the second plurality of environmental indicators generated for each image of the second set of images exceeding a consistency threshold; and
responsive to detecting a change between the selected first environmental indicators and the selected second environmental indicators, generating, by the at least one processor, a record identifying the detected change.
